(19) United States
(12) Patent Application Publication
(10) Pub. No.: US 2006/0196620 A1
(43) Pub. Date: Sep. 7, 2006

(54) Blind slat structure

(75) Inventor: Wen Ying Liang, Changhua County (TW)

Correspondence Address: TROXELL LAW OFFICE PLLC, 5205 LEESBURG PIKE, SUITE 1404, FALLS CHURCH, VA, 22041, US

(73) Assignee: Ching Feng Home Fashions Co., Ltd.

(21) Appl. No.: 11/099,648

(22) Filed: Apr. 6, 2005

(30) Foreign Application Priority Data
Mar. 1, 2005 (TW) 094203116

(51) Int. Cl. E06B 3/12

(52) U.S. Cl. 160/236

(57) ABSTRACT

An improved blind slat structure includes a slat body made of plastic materials, compound materials, glass fibers, and textile materials, and a pair of support members made of plastic materials, wood, compound materials and glass fibers symmetrically mounted to both elongate outer edges of the slat body thereon and securely fixed thereto via a connecting portion respectively, facilitating an easier and speedier manufacturing of the blind slat to achieve the economical efficiency thereof. Besides, via the connecting portions thereof, the blind slat obtained thereby can provide versatile stylistic change to boost the visual effect and achieve beautiful look in display thereof.

### BACKGROUND OF THE INVENTION

The present invention is related to an improved blind slat structure, including a slat body and a pair of support members symmetrically mounted to both elongate outer edges of the slat body thereon and securely fixed thereto via a connecting portion respectively; whereby, the blind slat obtained thereby can provide versatile stylistic change to boost the visual effect and achieve beautiful look in display thereof.

Please refer to FIG. 1. A conventional blind slat structure comprises a slat body 10 made of textile materials that is integrally woven into shape with a retaining space 11 formed at each elongate edge thereon for holding a support member 12 therein.

However, the conventional blind slat structure above contains some disadvantages. First, the slat body 10 is integrally made without any connecting portions disposed thereon for further decoration purpose and is prone to become defected with uneasily trimmed furry edges A formed in the production thereof which can easily destroy the look of the blind slat in display. Second, the support members 12 thereof must be accommodated into the retaining spaces 11 of the slat body 10 therein respectively, which is uneconomically troublesome in assembly and inflexibly dull in appearance thereof.

### SUMMARY OF THE PRESENT INVENTION

It is, therefore, the primary purpose of the present invention to provide an improved blind slat structure, including a slat body and a pair of support members directly mounted to both elongate outer edges of the slat body thereon and securely fixed thereto via a connecting portion respectively, facilitating an easier and speedier production of the blind slat thereof to achieve the economical efficiency thereby.

It is, therefore, the second purpose of the present invention to provide an improved blind slat structure wherein, via the connecting portions thereof, the blind slat obtained thereby can not only provide versatile stylistic change to boost the visual effect thereof, but also refrain from the problem of furry edges in production to achieve a neat and beautiful look in display thereof.

### BRIEF DESCRIPTION OF THE DRAWINGS

FIG. 1 is a perspective view of a conventional blind slat structure.

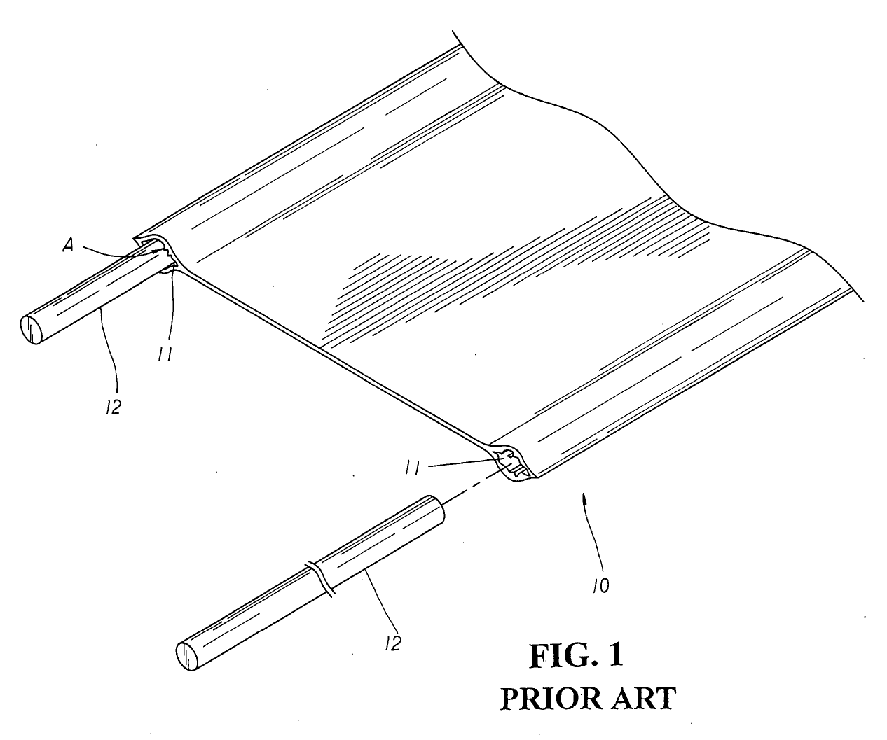

FIG. 2 is an exploded perspective view of the present invention.

FIG. 3 is a perspective view of the present invention in assembly.

FIG. 4 is another perspective view of the present invention in assembly.

FIG. 5 is a perspective view of another embodiment of the present invention in assembly.

FIG. 6 is a perspective view of a third embodiment of the present invention in assembly.

FIG. 7 is another perspective view of the third embodiment of the present invention in assembly.

### DETAILED DESCRIPTION OF THE PREFERRED EMBODIMENTS

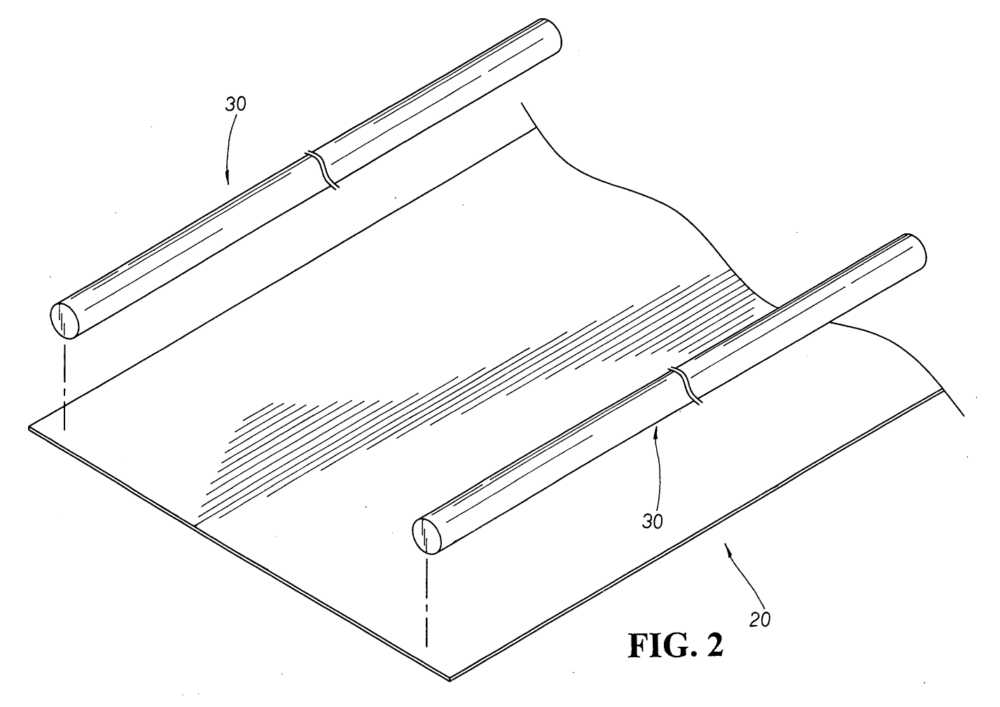

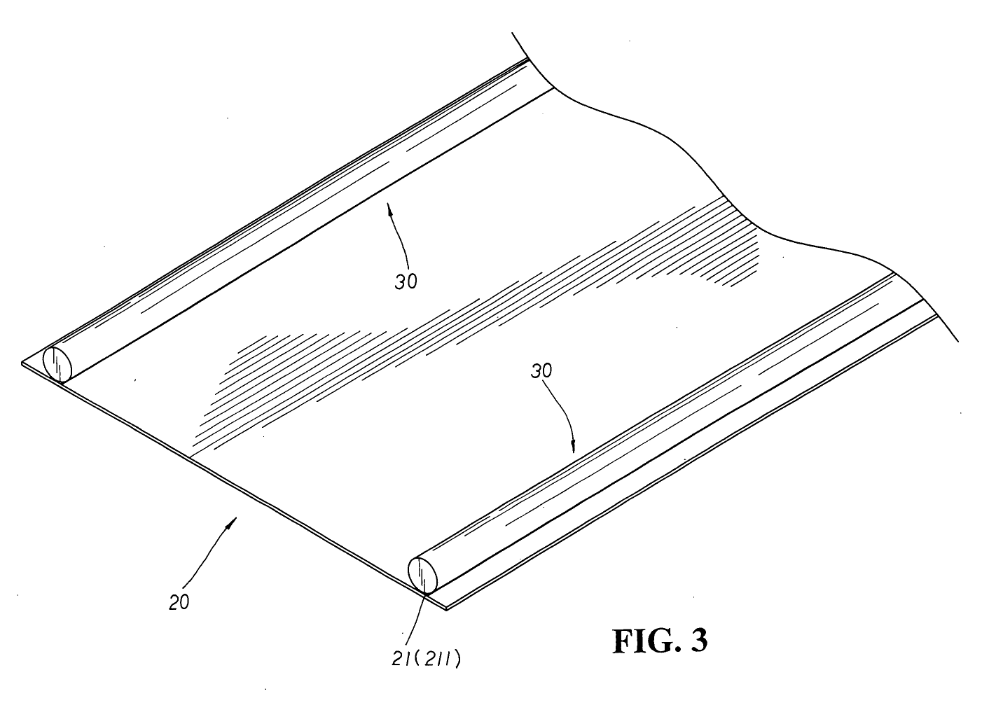

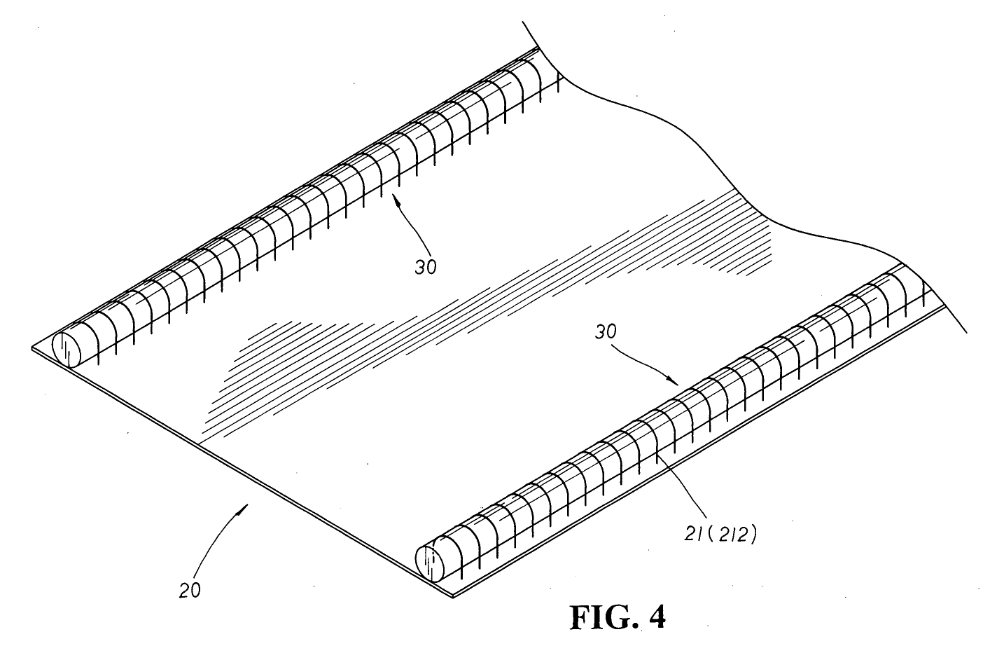

Please refer to FIGS. 2 through 4 inclusive. The present invention is related to an improved blind slat structure, including a slat body 20 made of plastic materials, compound materials, glass fibers, and textile materials, etc., and a pair of support members 30 made of plastic materials, wood, compound materials, and glass fibers, etc. that are directly and symmetrically mounted to both elongate outer edges at one side surface of the slat body 20 thereon and securely fixed thereto via a connecting portion 21 respectively wherein the connecting portion 21 can be made of adhesive agent 211 as shown in FIG. 3 or seam threads 212 integrally wound around the support members 30 for fixing thereby as shown in FIG. 4. Therefore, the blind slat obtained thereby is economically manufactured in an easy and speedy manner. Besides, via the connecting portions 21 thereof, the slat body 20 can not only achieve versatile stylistic change to boost the visual effect thereof, but also refrain from the problem of furry edges in production to achieve a neat and beautiful look of the blind slat in display thereof.

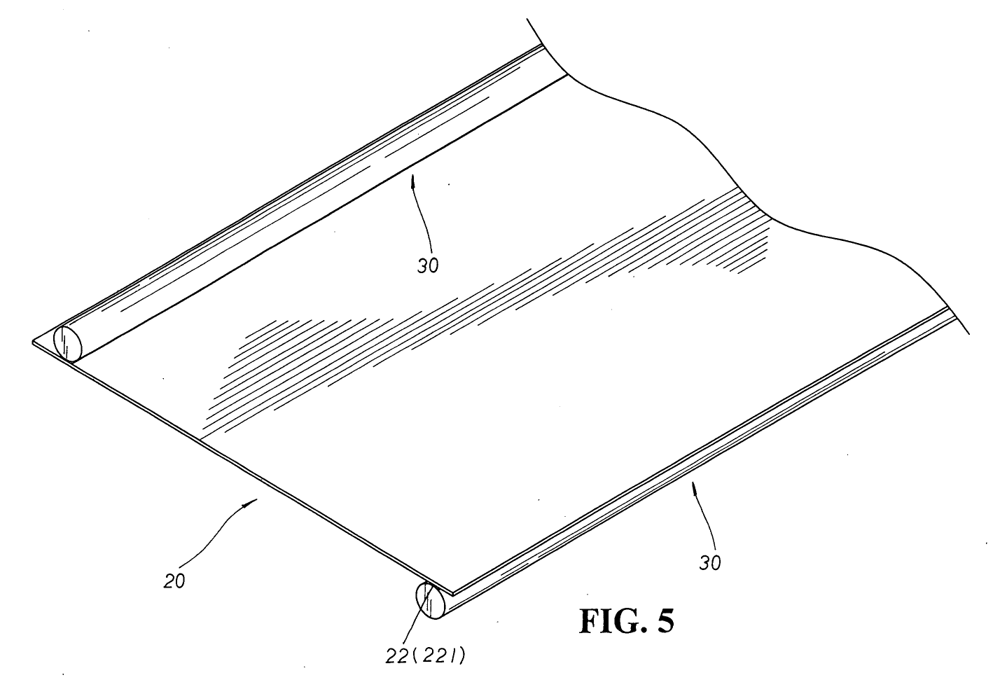

Please refer to FIG. 5 showing another embodiment of the present invention. The slat body 20 of the present invention can also have the support members 30 alternatively located at the opposite elongate edges of the upper and lower side surfaces thereon respectively and fixedly attached thereto via a connecting portion 22 made of adhesive agent 221 as shown in FIG. 5.

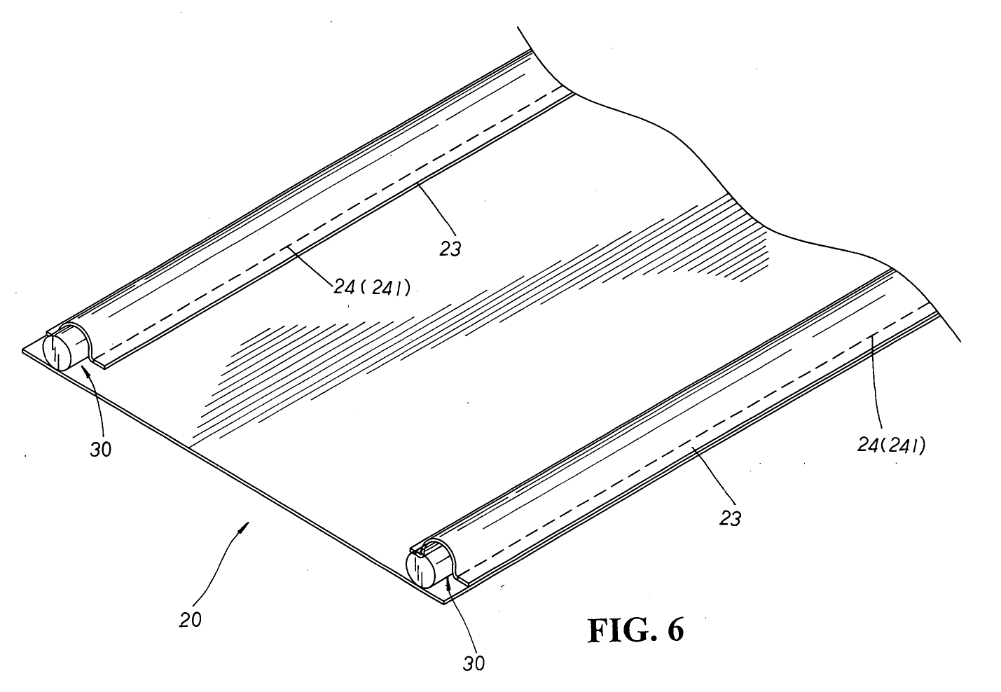

Please refer to FIG. 6 showing a third embodiment of the present invention. The slat body 20 of the present invention can also have a pair of wrapping layers 23 symmetrically disposed at both elongate outer edges of one side surface thereon or alternatively arranged at the opposite elongate edges of the upper and lower side surfaces thereon respectively for retaining the support members 30 therein and securely fixed thereto via connecting portions 24 like seam lines 241.

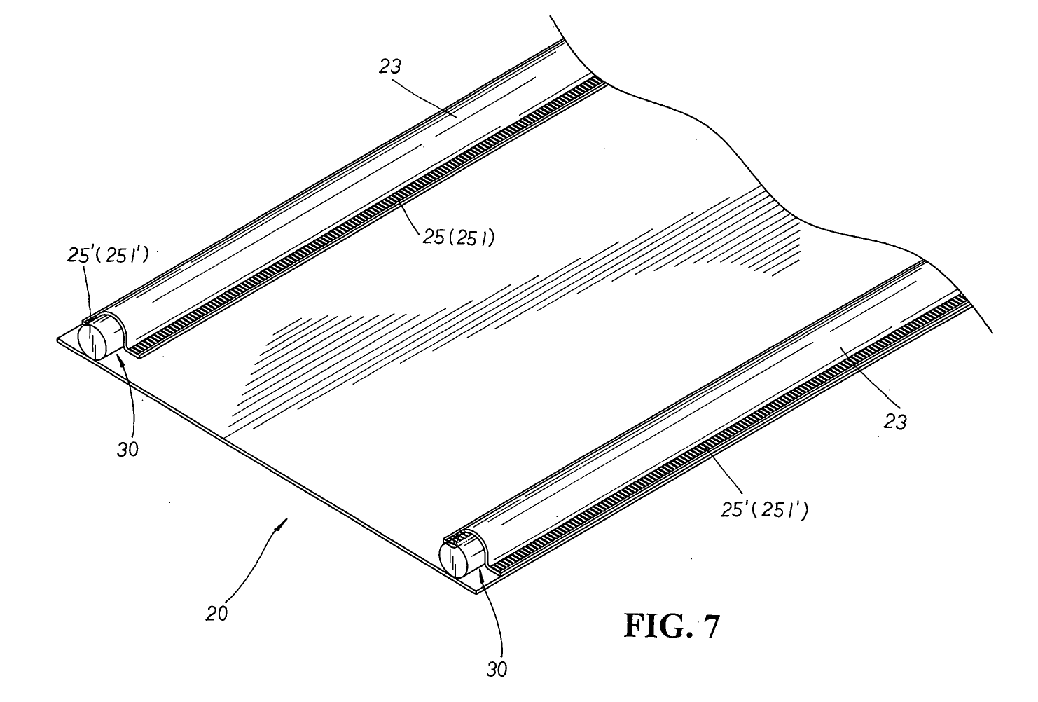

Please refer to FIG. 7 showing a fourth embodiment of the present invention. The slat body 20 of the present invention can also have a pair of wrapping layers 23 symmetrically arranged at both elongate outer edges of one side surface thereon for retaining the support members 30 thereby wherein each of the wrapping layers 23 is securely fixed to the slat body 20 via a set of inner and outer connecting portions 25, 25′ made of inner/outer ultrasonic thermo welding lines 251, 251′ as shown in FIG. 7.

In addition, the connecting portions 21, 22, 24 and the inner/outer connecting portions 25, 25′ of the slat body 20 can be mad of adhesive agent 211, 221, seam threads/lines 212, 241, and ultrasonic thermo welding lines 251, 251′ thereof.

What is claimed is:

1. An improved blind slat structure, including a slat body and a pair of support members directly and symmetrically mounted to both elongate outer edges of one side surface of the slat body thereon and securely fixed thereto via a connecting portion respectively, facilitating an economical manufacturing of the blind slat in an easy and speedy manner, and, via the connecting portions thereof, providing versatile stylistic change of the slat body to boost the visual effect and achieve beautiful look of the blind slat in display thereof.

2. The improved blind slat structure as claimed in claim 1 wherein the slat body thereof can be made of plastic materials, compound materials, glass fibers, and textile materials, etc.

3. The improved blind slat structure as claimed in claim 1 wherein connecting portions of the slat body thereof can be made of adhesive agent, seam threads/lines, and ultrasonic thermo welding lines, etc.

4. The improved blind slat structure as claimed in claim 1 wherein the support members can be symmetrically fixed at both elongate edges of one side surface of the slat body thereon.

5. The improved blind slat structure as claimed in claim 1 wherein the support members can also be alternatively fixed at the opposite elongate edges of the upper and lower side surfaces of the slat body thereon respectively.

6. The improved blind slat structure as claimed in claim 1 wherein the slat body can also have a pair of wrapping layers mounted at both elongate outer edges thereon for retaining a support member therein respectively wherein the wrapping layers are securely fixed to the slat body via a connecting portion respectively.

7. The improved blind slat structure as claimed in claim 6 wherein the wrapping layers thereof can be symmetrically mounted at both elongate edges of one side surface of the slat body thereon and securely fixed thereto.

8. The improved blind slat structure as claimed in claim 6 wherein the wrapping layers thereof can also be alternatively arranged and fixed to the opposite elongate edges of the upper and lower side surfaces of the slat body thereon respectively.
